(19) United States
(12) Patent Application Publication
(10) Pub. No.: US 2013/0257183 A1
(43) Pub. Date: Oct. 3, 2013

(54) STATOR PORTION OF MOLDED MOTOR, AND MOLDED MOTOR INCLUDING THE SAME

(71) Applicant: NIDEC CORPORATION, Kyoto (JP)

(72) Inventor: Tomoyoshi YOKOGAWA, Kyoto (JP)

(73) Assignee: NIDEC CORPORATION, Kyoto (JP)

(21) Appl. No.: 13/764,802

(22) Filed: Feb. 12, 2013

(30) Foreign Application Priority Data
Mar. 31, 2012 (JP) 2012-083399

(51) Int. Cl. H02K 5/02

(52) U.S. Cl. CPC H02K 5/02
USPC 310/43

(57) ABSTRACT

A stator portion of a molded motor includes a plurality of windings, a wiring board, and a resin arranged to cover at least a surface of each winding. The wiring board includes a through hole extending through the wiring board in an axial direction. The through hole is arranged axially opposite to any winding to facilitate discharge of air out of a gap between the wiring board and the winding during a molding process, while the distance between the wiring board and each opposed winding is short in the stator portion of the molded motor. The resin is thus continuously arranged in gaps between the windings and the gap between the wiring board and each opposed winding.

### BACKGROUND OF THE INVENTION

1. Field of the Invention

The present invention relates to a stator portion of a molded motor for use in an electronic device, and to a molded motor including the same.

2. Description of the Related Art

One known molded motor is disclosed, for example, in JP-A 8-280160.

In the molded motor disclosed in JP-A 8-280160, a gap between a wiring board and each winding is filled with a resin in order to promote dissipation of a heat from a heating element.

Here, when there is a demand for a motor having a smaller axial dimension, it is necessary to reduce the distance between a stator and the wiring board of the known molded motor disclosed in JP-A 8-280160. However, an inspection has found that the known molded motor does not provide a desired heat dissipation effect after the distance between the stator and the wiring board is reduced. The inventors of the present application discovered that this is because a gap is present between the wiring board and each winding. This gap is defined presumably because, when the stator is molded with a molding material, the molding material cannot easily enter into a gap between the wiring board and the winding since the gap between the wiring board and the winding is too small. That is, air that has not been discharged out of the gap between the wiring board and the winding remains in the gap even after the molding material is solidified, with the result that an air space or a large-sized air bubble exists in the gap between the wiring board and the winding. When the air space is present in the gap between the wiring board and the winding, heat generated in the winding cannot be efficiently dissipated through the resin, resulting in a reduction in heat dissipation efficiency of the winding.

It is possible to bring the winding into contact with the wiring board to attempt to eliminate the gap between the winding and the wiring board. However, this cannot completely eliminate a small gap between the winding and the wiring board because the winding has an uneven surface. As a result, the air space is inevitably defined between the wiring board and the winding when the stator is molded with the molding material, resulting in the reduction in the heat dissipation efficiency of the winding, as described above.

### SUMMARY OF THE INVENTION

According to a preferred embodiment of the present invention, a stator portion of a molded motor has a small axial dimension, and prevents an air space from being defined between a wiring board and a winding while allowing a molding material to be adhered to both the wiring board and the winding, so as to secure a sufficient heat dissipation effect.

A stator portion of a molded motor according to a preferred embodiment of the present invention includes a stator core including an annular core back and a plurality of teeth arranged to extend radially from the core back; an insulator arranged to cover the stator core; a plurality of windings each of which is attached to a separate one of the teeth while covering a portion of the insulator; a wiring board arranged on one axial side of the stator core, and including a conducting wire electrically connected to the windings arranged thereon; and a resin arranged to cover at least a surface of each winding. The wiring board includes at least one through hole extending through the wiring board. At least one of the at least one through hole is arranged axially opposite to any winding or a passage line extending between any two windings. A distance between the wiring board and an end of each opposed winding on a side where the wiring board is arranged is set to be shorter than a distance between mutually opposed side surfaces of every two circumferentially adjacent windings at radially outer ends of the windings. The resin is arranged continuously in gaps between the windings and a gap between the wiring board and each opposed winding.

Preferred embodiments of the present invention are able to provide a stator portion of a molded motor having a small axial dimension and in which the distance between a wiring board and each opposed winding is short, the stator portion being designed to facilitate discharge of air out of a gap between the wiring board and any opposed winding during a molding process, and to enable a resin to be arranged continuously in gaps between windings and a gap between the wiring board and each opposed winding so that the stator portion achieves high heat dissipation efficiency.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a vertical cross-sectional view of a molded motor according to a preferred embodiment of the present invention.

FIG. 2A is a plan view of a stator according to a preferred embodiment of the present invention.

FIG. 2B is a perspective view of the stator according to a preferred embodiment of the present invention.

FIG. 3 is a vertical cross-sectional view of a tooth of the stator according to a preferred embodiment of the present invention.

### DETAILED DESCRIPTION OF THE PREFERRED EMBODIMENTS

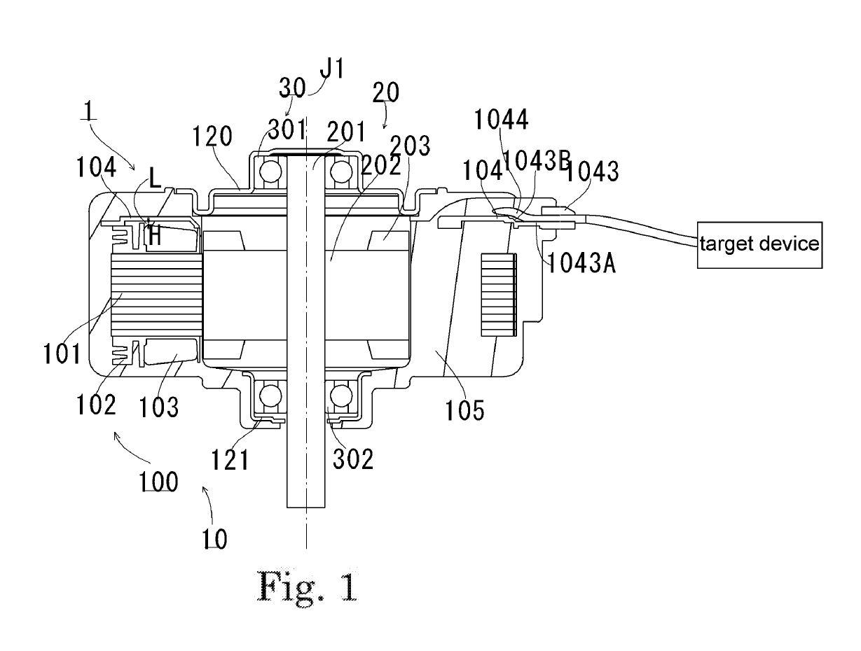

It is assumed herein that a vertical direction is defined as a direction in which a central axis J1 of a motor 1 extends, and that an upper side and a lower side along the central axis J1 in FIG. 1 are referred to simply as an upper side and a lower side, respectively. It should be noted, however, that the above definitions of the vertical direction and the upper and lower sides should not be construed to restrict relative positions or directions of different members or portions when the motor 1 is actually installed in a device. Also note that a direction parallel or substantially parallel to the central axis J1 is referred to by the term “axial direction”, “axial”, or “axially”, that directions perpendicular or substantially perpendicular to the central axis J1 are referred to by the term “horizontal direction”, “horizontal”, or “horizontally”, that, of all horizontal directions, directions of radii of a circle centered on the central axis J1 are simply referred to by the term “radial direction”, “radial”, or “radially”, and that a circumferential direction about the central axis J1 is simply referred to by the term “circumferential direction”, “circumferential”, or “circumferentially”.

FIG. 1 is a vertical cross-sectional view of a molded motor (hereinafter referred to as a “motor”) 1 according to a preferred embodiment of the present invention. The motor 1 is preferably used in, for example, a fan, an air conditioner, an air purifier, a range hood, a water heater, a humidifier, a blower, etc. The motor 1 is preferably an inner-rotor motor, for example.

The motor 1 includes a stator portion 10, a rotor portion 20, and a bearing portion 30. The bearing portion 30 preferably includes a first ball bearing 301 and a second ball bearing 302. The second ball bearing 302 is arranged below the first ball bearing 301.

The stator portion 10 preferably includes a first bearing support portion 120, a second bearing support portion 121, a stator 100, and a resin 105. Each of the first and second bearing support portions 120 and 121 is preferably shaped by, for example, subjecting a plate material to a pressing process. The stator 100 preferably includes a stator core 101, an insulator 102 made of a resin, a plurality of windings 103, and a wiring board 104. The wiring board 104 is arranged substantially horizontally on an axially upper side of the stator core 101. An end surface of the wiring board 104 on a side where the windings 103 are arranged, that is, a lower surface of the wiring board 104, is arranged to be in contact with the insulator 102, so that the axial position of the wiring board 104 is determined. The distance between the lower surface of the wiring board 104 and an end of each opposed winding 103 on a side where the wiring board 104 is arranged, that is, an axially upper end of each opposed winding 103, is thus set at a fixed value. In the present preferred embodiment, the distance between the lower surface of the wiring board 104 and the upper end of each opposed winding 103 is preferably set at a small value to enable the molded motor 1 to have a small axial dimension.

A conducting wire 1044 electrically connected to the windings 103 is preferably arranged on an upper side of the wiring board 104, that is, on an opposite side of the wiring board 104 to the windings 103. The conducting wire 1044 is connected to a connector 1043. The wiring board 104 of the motor 1 is connected to a target device through the connector 1043. A power supply and electronic components are installed in the target device to drive the motor 1. Installation of the components arranged to drive the motor 1 in the target device contributes to reducing the area of the wiring board 104, and thus improving a heat dissipation effect related to the stator 100.

The rotor portion 20 is supported by the bearing portion 30 such that the rotor portion 20 is rotatable about the central axis J1 with respect to the stator portion 10. The rotor portion 20 preferably includes a shaft 201, a rotor core 202, and end rings 203. The shaft 201 is supported by the first and second ball bearings 301 and 302 such that the shaft 201 is rotatable about the central axis J1. An output end of the shaft 201 is preferably arranged to project downward through an opening defined in the second bearing support portion 121. The rotor core 202 preferably is defined by, for example, laminated steel sheets, and is arranged radially inside the stator 100. However, any other desirable type of rotor core could be used instead. The end rings 203 preferably are each annular in shape, and are arranged on an upper surface and a lower surface of the rotor core 202. A plurality of spaces each extending in an axial direction are defined in the rotor core 202, and the spaces are arranged in a circumferential direction. Each of these spaces is preferably filled with a metal when the end rings 203 are molded by, for example, a die casting process. The end rings 203 are connected with the metal filled into the spaces in the rotor core 202, whereby a squirrel-cage rotor is defined.

The distance between the connector 1043 and an axially lowermost end of the stator portion 10 is determined in accordance with the dimensions of the target device. In the present preferred embodiment, the stator core 101 is arranged to have a large axial dimension in order to improve efficiency of the motor 1. However, the axial position of an upper surface of a connector board 1043A is preferably arranged to be lower than the axial position of an upper surface of the wiring board 104 in order to allow the connector 1043 to have an axial dimension demanded by the dimensions of the target device. This axial displacement between the upper surface of the connector board 1043A and the upper surface of the wiring board 104 is realized by a shoulder 1043B defined therebetween.

In the present preferred embodiment, an axially upper top of each winding 103 is located at a point H of an axially upper end of a radially outer portion of the winding 103. Because the wiring board 104 is arranged substantially horizontally as described above, the distance between the winding 103 and the wiring board 104 is preferably shortest at the top H of the winding 103. In other words, the distance L between the top H of the winding 103 and the lower surface of the wiring board 104 corresponds to the shortest distance between the winding 103 and the wiring board 104.

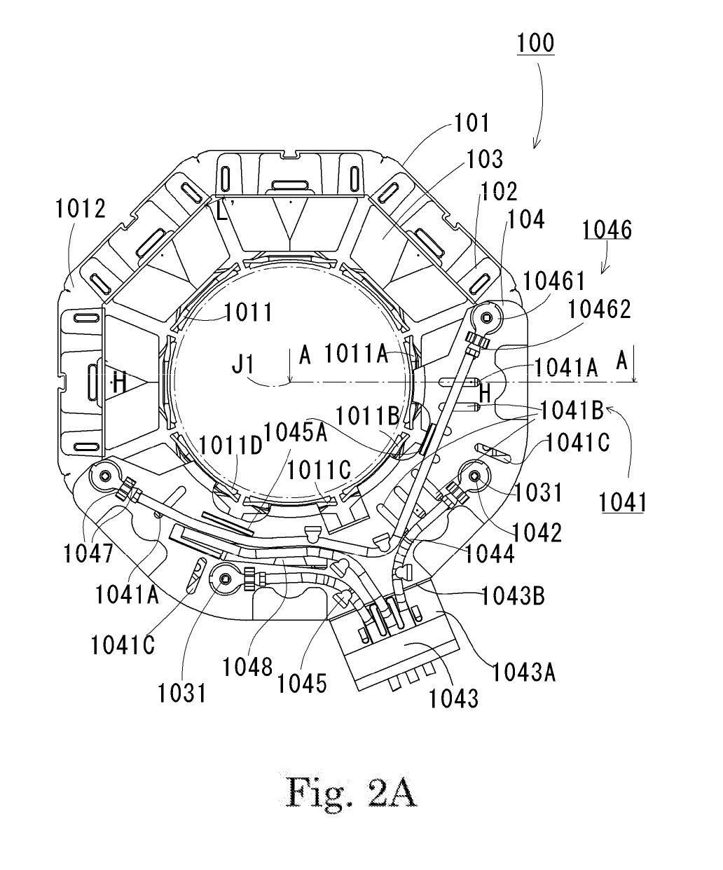

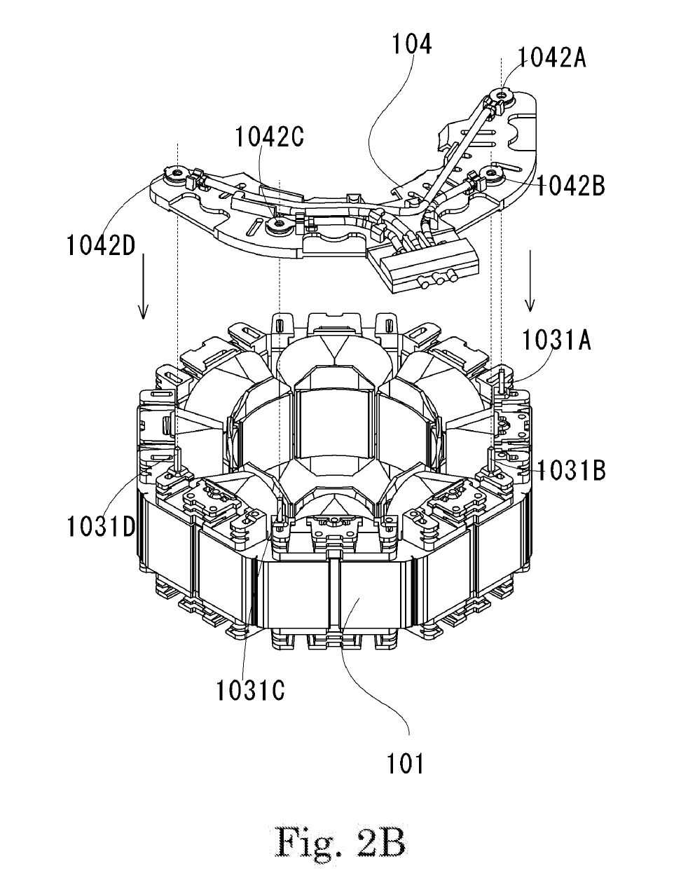

FIG. 2A is a plan view of the stator 100. FIG. 2B is a perspective view of the stator 100 prior to a molding process and a process of fixing the wiring board 104 to the stator core 101. Hereinafter, reference will be made to FIGS. 2A and 2B. In FIG. 2A, the rotor core 202 is represented by a chain a dot-dashed line. Note that the windings 103 are only shown schematically, and the actual unevenness in shape and the like of each winding 103 is not depicted. The stator 100 is preferably arranged to have a substantially octagonal external shape with a center at the central axis J1. The stator core 101 is preferably defined by, for example, laminated magnetic steel sheets each of which is in the shape of a thin plate. However, any other desirable type of stator core could be used instead. The stator core 101 is preferably covered by the insulator 102 except for an outer circumferential surface and an inner circumferential surface thereof and their vicinities. The stator core 101 preferably includes, for example, eight teeth 1011 and an annular core back 1012. The teeth 1011 are arranged to extend radially inward from the core back 1012 toward the rotor core 202. Each of the windings 103 is preferably defined by a copper wire 1033 wound around a separate one of the teeth 1011. That is, each winding 103 is attached to a separate one of the teeth 1011 while covering a portion of the insulator 102. In the stator 100, the windings 103 are preferably defined by, for example, a so-called concentrated winding method.

The lower surface of the wiring board 104 is preferably axially opposed to a half of the eight teeth 1011, that is, four of the teeth 1011, and the wiring board 104 is arranged to assume the shape of a circular arc when viewed from above in the axial direction. In the present preferred embodiment, the distance L (see FIG. 1) between the wiring board 104, more specifically, the lower surface of the wiring board 104, and the end of each opposed winding 103 on the side where the wiring board 104 is arranged, that is, the axially upper top H of each opposed winding 103, is arranged to be shorter than the distance L′ between mutually opposed side surfaces of every two circumferentially adjacent windings 103 at radially outer ends of the windings 103. This arrangement enables the motor 1 to have a reduced axial dimension, i.e., a reduced thickness.

Referring to FIG. 2A, a rightmost one of the teeth 1011 covered by the wiring board 104 is referred to as a first tooth 1011A, and the other teeth 1011 covered by the wiring board 104 are referred to as a second tooth 1011B, a third tooth 1011C, and a fourth tooth 1011D, respectively, in a clockwise order. In addition, the windings 103 defined around the aforementioned teeth 1011A, 1011B, 1011C, and 1011D are referred to as a first winding 103A, a second winding 103B, a third winding 103C, and a fourth winding 103D, respectively.

Referring to FIGS. 2A and 2B, terminal pins 1031 including four terminal pins 1031A, 1031B, 1031C, and 1031D, to which winding end portions of the windings 103 are soldered, are preferably fixed to portions of the teeth 1011A, 1011B, 1011C, and 1011D, respectively, which are covered by the insulator 102. The wiring board 104 preferably includes penetrating holes 1042 including penetrating holes 1042A, 1042B, 1042C, and 1042D corresponding to the four terminal pins 1031A, 1031B, 1031C, and 1031D, respectively. When the wiring board 104 and the stator core 101 are fixed to each other, the four terminal pins 1031A, 1031B, 1031C, and 1031D, which are electrically connected with the winding end portions of the windings 104 preferably through, for example, soldering, are inserted into the penetrating holes 1042A, 1042B, 1042C, and 1042D, respectively. This contributes to ensuring electrical continuity between the windings 103 and the conducting wire 1044. In the following description, the terminal pins corresponding to the teeth 1011A, 1011B, 1011C, and 1011D will be referred to as a first terminal pin 1031A, a second terminal pin 1031B, a third terminal pin 1031C, and a fourth terminal pin 1031D, respectively.

In the present preferred embodiment, electrical continuity is established between the first and fourth terminal pins 1031A and 1031D, while each of the second and third terminal pins 1031B and 1031D is connected to the target device through the connector 1043. The first and fourth terminal pins 1031A and 1031D are connected to each other through the conducting wire 1044, and the connector 1043 and each of the second and third terminal pins 1031B and 1031D are connected to each other through the conducting wire 1044. Note that a pattern in which the connector 1043 and the first, second, third, and fourth terminal pins 1031A, 1031B, 1031C, and 1031D are connected to one another is not limited to the above-described pattern and any other desirable pattern is usable instead. The conducting wire 1044 is arranged on the upper side of the wiring board 104, and conducting wire guide portions 1045 are arranged to guide the direction of wiring of the conducting wire 1044. Although it is desirable that each conducting wire guide portion 1045 should be arranged at a position at which the direction of extension of the conducting wire 1044 changes, each conducting wire guide portion 1045 may be arranged at a position at which the conducting wire 1044 extends straight in a horizontal direction. Each conducting wire guide portion 1045 is preferably in the shape of a claw, extending first axially upward from the wiring board 104 and then bending horizontally, but may alternatively be in the shape of a wall, simply standing upright in the axial direction (see conducting wire guide portions 1045A), or any other desirable shape. The conducting wire guide portions 1045 enable the conducting wire 1044 to be fixed at a predetermined wiring position on the wiring board 104. In addition, by providing the conducting wire guide portions 1045, it is easy to simulate a wiring path of the conducting wire 1044, making it possible to accurately calculate the length of the conducting wire 1044. Note that, if the conducting wires 1044 are manufactured with the total length of each of the conducting wires 1044 set at a fixed value, the length of a harness connected from the connector 1043 to the target device can also be set at a fixed value, preferably making variations between products unlikely to occur.

Electrical connection between each terminal pin 1031 and the conducting wire 1044 is preferably accomplished through a round terminal 1046. The round terminal 1046 preferably includes a ring-shaped portion 10461 and an arm portion 10462. The ring-shaped portion 10461 includes a central hole into which the terminal pin 1031 is inserted. The arm portion 10462 extends outward from a portion of the ring-shaped portion 10461, and is connected to the conducting wire 1044. The hole of the ring-shaped portion 10461 is preferably arranged to axially coincide with a corresponding one of the penetrating holes 1042 defined in the wiring board 104, and the terminal pin 1031 is inserted into both the hole of the ring-shaped portion 10461 and the penetrating hole 1042. The arm portion 10462 is preferably fixed onto the wiring board 104 by, for example, crimping at an end portion thereof which is connected to the conducting wire 1044, and by using a terminal fixing portion 1047 at a portion thereof which is not the end portion thereof connected to the conducting wire 1044. The round terminal 1046, having the terminal pin 1031 inserted into the ring-shaped portion 10461 thereof, is preferably fixed to the wiring board 104 as a result of the round terminal 1046 being soldered to the terminal pin 1031. The round terminal 1046 does not move in the axial direction because the round terminal 1046 is fixed onto the wiring board 104 by crimping at the end portion thereof which is connected to the conducting wire 1044, and by the terminal fixing portion 1047 at a position midway through the length of the arm portion 10462 thereof. Therefore, a fillet of a solder arranged on the ring-shaped portion 10461 is formed in an appropriate manner, easily ensuring sufficient strength with which the round terminal 1046 is soldered to the terminal pin 1031.

The wiring board 104 preferably includes through holes 1041. In the present preferred embodiment, many of the through holes 1041 preferably are each defined in the shape of a slit, however, any other desirable shape may be used. Each through hole 1041 in the shape of the slit is arranged to have a length extending substantially parallel to a radial direction, and extends through the wiring board 104. Note that each through hole 1041 in the shape of the slit may not necessarily be arranged to have the length extending parallel or substantially parallel to the radial direction in other preferred embodiments of the present invention. The through holes 1041 preferably include main slits 1041A, secondary slits 1041B, and through holes 1041C. The main slits 1041A of the wiring board 104 are arranged at positions axially opposed to the tops H of the first, second, and fourth windings 103A, 103B, and 103D. Each of the secondary slits 1041B of the wiring board 104 is arranged in the vicinity of one of the main slits 1041A, that is, at a position axially opposed to a portion of one of the windings 103 other than the top H. In the present preferred embodiment, one of the secondary slits 1041B is defined in the wiring board 104 at a position axially opposed to the first winding 103A, while two of the secondary slits 1041B are defined in the wiring board 104 at positions axially opposed to the second winding 103B. Note that a greater number of secondary slits than the number of secondary slits 1041B according to the present preferred embodiment may be provided in other preferred embodiments of the present invention, in the case where the wiring board has sufficient dimensions. Also note that, conversely, other preferred embodiments of the present invention may not include any secondary slits, in a case where the wiring board does not have sufficient dimensions for any secondary slits.

Connection between the windings 103 is preferably established through a passage line (not shown) extending between the teeth 1011. In the present preferred embodiment, each of the through holes 1041C of the wiring board 104 preferably is arranged at a position axially opposed to the passage line between the teeth 1011. Each through hole 1041C contributes to accomplishing filling of the resin 105 without permitting an air space to be defined between the wiring board 104 and the passage line.

The wiring board 104 preferably includes a thermal fuse arrangement hole 1048 at a position axially opposed to the third winding 103C. The thermal fuse arrangement hole 1048 extends through the wiring board 104. A thermal fuse (not shown) is arranged such that the whole thermal fuse or a portion thereof is accommodated in the thermal fuse arrangement hole 1048. The thermal fuse is used to measure the temperature of the motor 1, and is designed to blow out (i.e., fail) when the temperature becomes too high while the motor 1 is in operation. While the motor 1 is rotating, the temperature of the motor 1 becomes highest near each winding 103. It is therefore desirable that the thermal fuse should be arranged as close as possible to any one of the windings 103. Arranging the thermal fuse such that the whole thermal fuse or a portion thereof is accommodated in the thermal fuse arrangement hole 1048 makes it possible to detect the temperature of a position near one of the windings 103, and also makes it possible to reduce the axial dimension of the motor 1. In the present preferred embodiment, the thermal fuse arrangement hole 1048 is arranged in the wiring board 104 at a position axially opposed to the top H of the third winding 103C. This makes it possible to precisely detect the temperature of one of the windings 103. It is desirable that the thermal fuse arrangement hole 1048 should be shaped to extend in the circumferential direction along the direction of extension of the copper wire 1033 of the third winding 103C. The thermal fuse arrangement hole 1048 having this shape enables the thermal fuse to be opposed to the third winding 103C in a wide area, enabling the thermal fuse to measure the temperature of the third winding 103C more precisely.

The stator 10 is preferably molded with the resin 105 in order to promote dissipation of a heat generated during rotation of the motor 1 according to the present preferred embodiment. Because the resin 105 has a higher thermal conductivity than that of air, covering surfaces of the stator core 101 and the windings 103 with the resin 105 facilitates efficient dissipation of the heat. Moreover, molding the stator 10 with the resin 105 makes the stator 10 resistant to dust and water.

The molding of the stator 100 with the resin according to the present preferred embodiment will now be described in more detail below. When the stator 100 is molded with the resin, a liquid resin is gradually loaded into gaps between the windings 103 and a gap between the wiring board 104 and each of the windings 103 opposed to the wiring board 104. The distance between the wiring board 104 and each opposed winding 103 is short in the motor 1 according to the present preferred embodiment. Therefore, when the liquid resin flows around the top H of each winding 103, the liquid resin adheres to the surfaces of the wiring board 104 and the winding 103 around the top H due to action of surface tension. Here, because the through holes 1041, especially the main slits 1041A and the thermal fuse arrangement hole 1048, are arranged in the wiring board 104 at positions opposed to the tops H of the windings 103, air present near the tops H is discharged axially upwardly out of the wiring board 104 through the through holes 1041. As a result, the resin 105 is loaded while adhering to the surfaces of the wiring board 104 and the windings 103, without permitting an air space to remain in the gap between the wiring board 104 and any winding 103. In short, each through hole 1041 plays the role of an air escape portion. As a result, the resin 105 fills the gaps between the windings 103, that is, the gap between every adjacent pair of windings 103, the gap between the wiring board 104 and each opposed winding 103, and a space enclosed by an inner wall of each through hole 1041. This means that the resin is arranged continuously in the gaps between the windings 103, that is, the gap between every adjacent pair of windings 103, the gap between the wiring board 104 and each opposed winding 103, and the space enclosed by the inner wall of each through hole 1041 while covering the surface of each winding 103. The motor 1 thus improves in the heat dissipation effect. Conversely, if the wiring board 104 did not include any through hole as the air escape, it would be difficult to discharge the air, and the air space would be easily defined between the wiring board 104 and any opposed winding 103. Provision of the through holes preferably prevents the occurrence of the air space, or permits only a relatively small air space to be formed.

If an air space is defined between the wiring board 104 and any winding 103, a heat radiated from the winding 103 cannot be dissipated efficiently through the resin 105. Moreover, a resin surface is defined at an interface between the resin 105 and a remaining air, and an edge of the resin surface will be in contact with the winding 103. Thermal expansion/contraction of the resin 105 or a vibration of the motor 1 may cause the edge of the resin surface to be rubbed against the winding 103, which might cause a film with which a surface of the copper wire 1033 defining the winding 103 is coated to peel off, leading to a short circuit or a break in the copper wire 1033. Note that the air space which is regarded as a problem is a large-sized air bubble which occurs due to poor loading of the resin, and not a minute air bubble which commonly occurs in the molding resin.

As described above, the wiring board 104 includes the through holes 1041 at the positions axially opposed to some of the windings 103 and some of the passage lines extending between the windings 103. This preferably enables the resin to be arranged continuously in the gaps between the windings and the gap between the wiring board and each opposed winding even in the case of the molded motor having a small axial dimension, and especially even in the case of the molded motor in which the distance between the wiring board and the end of each opposed winding on the side where the wiring board is arranged is shorter than the distance between the mutually opposed side surfaces of every two circumferentially adjacent windings at the radially outer ends of the windings, and facilitates discharge of air between the wiring board and any winding, making it possible to secure sufficient heat dissipation efficiency of the stator. Some of the through holes are preferably arranged in the wiring board 104 at the positions axially opposed to the ends of the windings 103 on the side where the wiring board 104 is arranged, that is, the axial tops H of the windings 103. This further reduces the likelihood that a gap will occur between the wiring board 104 and any winding 103 when the molding is complete, making it possible to secure sufficient heat dissipation efficiency more effectively.

In the present preferred embodiment, each of the through holes 1041 defined in the wiring board 104 is in the shape of the slit. Note, however, that the shape of each through hole 1041 is not limited to the shape of the slit, but may otherwise be decided appropriately to be any other shape. For example, each through hole 1041 may be in the shape of a polygon or a circle in a plan view.

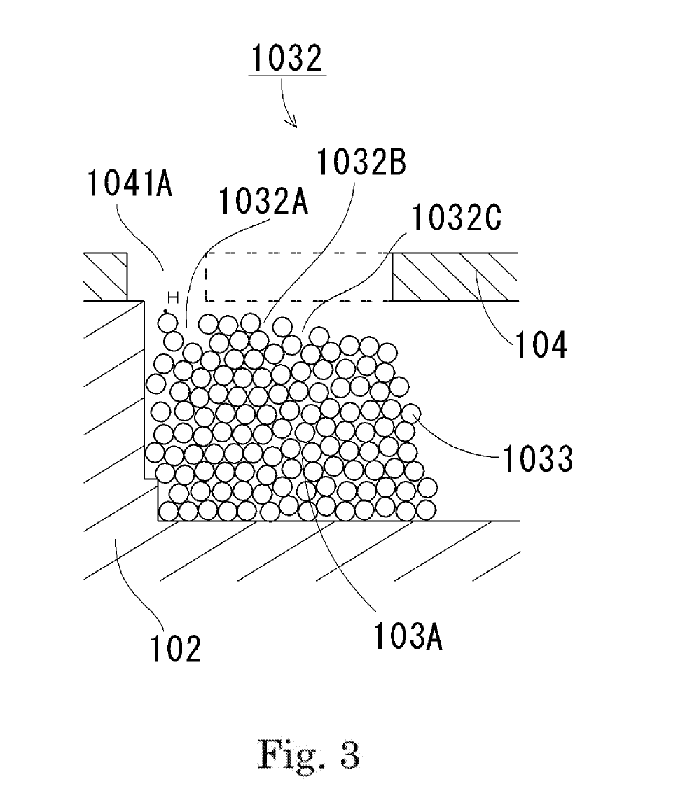

It should be noted, however, that each through hole 1041 being in the shape of the slit facilitates the discharge of the air. Reasons for that will now be described below with reference to FIG. 3.

FIG. 3 is a cross-sectional view of the first tooth 1011A taken along line A-A in FIG. 2A. The copper wire 1033 is wound around the insulator 102 a plurality of times to define the first winding 103A. The wiring board 104 is arranged axially above the first winding 103A. The main slit 1041A (i.e., the through hole 1041) extending through the wiring board 104 is defined in the wiring board 104. In FIG. 3, of the copper wire 1033 defining the first winding 103A, only portions thereof which are in the vicinity of the through hole 1041 are shown.

When the copper wire 1033 is wound around a surface of the insulator 102, gaps 1032 including, for example, gaps 1032A, 1032B, and 1032C illustrated in FIG. 3 inevitably occur. Here, if the through hole 1041 defined in the wiring board 104 had a small radial dimension, more specifically, if an area indicated by a broken line in FIG. 3 defined not a portion of the through hole 1041 but a portion of the wiring board 104, air in the gap 1032A, which is axially opposed to the through hole 1041, would be easily discharged through the through hole 1041, but air in each of the gaps 1032B and 1032C would not be easily discharged, when the stator 10 is molded with the resin.

In contrast, when the through hole 1041 is in the shape of a slit having a large radial dimension, more specifically, when the area indicated by the broken line in FIG. 3 defines a portion of the through hole 1041, an area over which the first winding 103A and the through hole 1041 are axially opposed to each other when the stator 10 is molded with the resin is enlarged, facilitating discharge of air in each of all the gaps 1032 including the gaps 1032B and 1032C. That is, arranging the through hole 1041 in the shape of the slit to extend substantially parallel to the radial direction makes it easier for all air between the wiring board 104 and the first winding 103A to be discharged when the stator 10 is molded with the resin.

As described above, the conducting wire 1044 is arranged on the upper side of the wiring board 104, that is, on the opposite side of the wiring board 104 to the windings 103. In addition, as illustrated in FIG. 2A, each through hole 1041 is preferably in the shape of the slit, and the longitudinal direction of the slit is preferably arranged to cross the direction of extension of a portion of the conducting wire which passes above the slit, that is, which is axially opposed to the slit. This arrangement contributes to preventing the conducting wire 1044 above the wiring board 104 from falling into the through hole 1041, and from closing the through hole 1041 or making contact with the winding 103. In particular, if the through hole 1041 is closed by the conducting wire 1044, the air cannot be easily discharged through the through hole 1041 when the stator 100 is molded with the resin, and the through hole 1041 cannot properly fulfill its function as an air escape portion. If the conducting wire 1044 makes contact with the winding 103, a short circuit may occur. Such problems can be avoided by arranging the longitudinal direction of the slit to cross the direction of the extension of the conducting wire 1044. Note that the conducting wire 1044 does not fall into the through hole 1041 if the through hole 1041 in the shape of the slit is arranged to have a width smaller than the diameter of the conducting wire 1044, even if the longitudinal direction of the slit is not arranged to cross the direction of the extension of the portion of the conducting wire 1044 which is axially opposed to the slit.

In the present preferred embodiment, the axially upper top H of each winding 103 is preferably the end of the winding 103 on the side where the wiring board 104 is arranged. In practice, however, it may be difficult to identify the top H of the winding 103 because of uneven design or operational quality. It should therefore be considered sufficient if the end of the winding 103 on the side where the wiring board 104 is arranged, which should be identified in order to clarify the position of the through hole 1041, especially the main slit 1041A, in the wiring board 104, is interpreted as an area including the axially upper top H of the winding 103 and its vicinity. In short, certain flexibility is allowed in determining the position of each through hole 1041, especially each main slit 1041A, in the wiring board 104, insofar as the beneficial effect of successful discharge of the air when the stator portion 10 of the motor 1 is molded with the resin is achieved.

For example, note that, although the wiring board 104 according to the above-described preferred embodiment is preferably used to fix the winding end portions of the windings 103 and to connect the windings 103 to the power supply and circuit components installed in the target device, the electronic components arranged to drive the motor, which are commonly installed in the target device, may be mounted on the wiring board 104. In this case, not only the stator core 101 and the windings 103 but also the electronic components mounted on the wiring board 104 radiate heat, and the surface of the wiring board 104 may also be covered with the resin 105 to improve heat dissipation efficiency of the electronic components. Moreover, in that case, the wiring board 104 may be arranged in an annular shape to secure a sufficient space to permit arrangement of the electronic components.

The wiring board 104 is preferably arranged to cover the half of the teeth 1011, i.e., four of the teeth 1011, in the above-described preferred embodiment. Note, however, that the number of teeth 1011 which are covered by the wiring board 104, or the proportion of the teeth 1011 which are covered by the wiring board 104 to all the teeth 1011, may be arbitrarily determined as appropriate. That is, the shape of the wiring board 104 is not limited to a semicircle, but may be a circular arc of more than about 180 degrees or a circular arc of less than about 180 degrees, for example. Arranging the wiring board 104 in the shape of a circular arc reduces the area of a portion of the stator 100 which is covered by the wiring board 104 compared to the case where the wiring board 104 is annular in shape, and leads to a reduction in a material cost of the wiring board 104 and an improvement in the heat dissipation effect of the windings 103. Also note that the number of slots of the stator core 101 is not limited to eight, but the number of teeth 1011 may be arbitrarily determined as appropriate.

Although each winding 103 is preferably made of copper in the above-described preferred embodiment, the windings may be made of aluminum, or any other desirable electrically conducting material, in other preferred embodiments of the present invention.

While the stator according to the above-described preferred embodiment is preferably for use in an inner-rotor motor, for example, stators according to other preferred embodiments of the present invention may be designed for use in outer-rotor motors. Also note that it may be difficult to discharge air which is not between any winding and the wiring board but is instead between any winding and a circuit board or between any winding and a base portion of a motor. In this case, the through holes 1041 are defined in the circuit board or in the base portion of the motor. Also, it is assumed in the above-described preferred embodiment that the distance between the wiring board 104 and each opposed winding 103 is shortest at the point H of the axially upper end of the radially outer portion of the winding 103. In practice, however, the top H of the winding 103 may not necessarily be located at the aforementioned point, because of uneven design or operational quality. In that case, the through hole may be defined at a position at which the distance between the wiring board and the winding is shortest, as in the above-described preferred embodiment.

Features of the above-described preferred embodiments and the modifications thereof may be combined appropriately as long as no conflict arises.

Preferred embodiments of the present invention are applicable to motors used for a variety of applications. In particular, preferred embodiments of the present invention are suitably applicable to motors for use in fans, air conditioners, air purifiers, range hoods, water heaters, humidifiers, and blowers, for example.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A stator portion of a molded motor, the stator portion comprising:
a stator core including an annular core back and a plurality of teeth arranged to extend radially from the core back;
an insulator arranged to cover the stator core;
a plurality of windings each of which is attached to a separate one of the teeth while covering a portion of the insulator;
a wiring board arranged on one axial side of the stator core, and including a conducting wire electrically connected to the windings arranged thereon; and
a resin arranged to cover at least a surface of each winding; wherein
the wiring board includes at least one through hole extending through the wiring board;
at least one of the at least one through hole is arranged axially opposite to any winding or a passage line extending between any two windings;
a distance between the wiring board and an end of each opposed winding on a side where the wiring board is arranged is shorter than a distance between mutually opposed side surfaces of every two circumferentially adjacent windings at radially outer ends of the windings; and
the resin is arranged continuously in gaps between the windings and a gap between the wiring board and each opposed winding.

2. The stator portion of the molded motor according to claim 1, wherein at least one of the at least one through hole arranged axially opposite to any winding or the passage line extending between any two windings is arranged in the wiring board at a position axially opposed to at least an end of any winding on the side where the wiring board is arranged.

3. The stator portion of the molded motor according to claim 1, wherein at least one of the at least one through hole arranged axially opposite any winding or the passage line extending between any two windings has a slit shape.

4. The stator portion of the molded motor according to claim 2, wherein at least one of the at least one through hole arranged axially opposite to any winding or the passage line extending between any two windings has a slit shape.

5. The stator portion of the molded motor according to claim 4, wherein at least one of the at least one through hole having a slit shape is arranged to have a length extending in a radial direction.

6. The stator portion of the molded motor according to claim 5, wherein
the conducting wire is arranged on a side of the wiring board that is opposite to the windings; and
a longitudinal direction of at least one of the at least one through hole having a slit shape is arranged to cross a direction of extension of a portion of the conducting wire which is axially opposed to the through hole having a slit shape.

7. The stator portion of the molded motor according to claim 4, wherein at least one of the at least one through hole has a width smaller than a diameter of the conducting wire.

8. The stator portion of the molded motor according to claim 2, wherein the resin is arranged to fill the gaps between the windings, the gap between the wiring board and each opposed winding, and a space enclosed by an inner wall of each of the at least one through hole arranged at the position axially opposed to at least the end of any winding on the side where the wiring board is arranged.

9. The stator portion of the molded motor according to claim 5, wherein the resin is arranged to fill the gaps between the windings, the gap between the wiring board and each opposed winding, and a space enclosed by an inner wall of each of the at least one through hole arranged at the position axially opposed to at least the end of any winding on the side where the wiring board is arranged.

10. The stator portion of the molded motor according to claim 1, wherein the wiring board is connected to a target device through a connector, the target device including components arranged to drive the motor installed therein.

11. The stator portion of the molded motor according to claim 6, wherein the wiring board is connected to a target device through a connector, the target device including components arranged to drive the motor installed therein.

12. The stator portion of the molded motor according to claim 6, wherein the wiring board includes a penetrating hole including a terminal pin electrically connected to any winding inserted into the penetrating hole.

13. The stator portion of the molded motor according to claim 6, wherein the wiring board has an annular shape.

14. The stator portion of the molded motor according to claim 6, wherein the wiring board has a circular arc shape.

15. The stator portion of the molded motor according to claim 6, wherein an end surface of the wiring board on a side where the windings are arranged is in contact with the insulator.

16. A molded motor comprising:
the stator portion of the molded motor according to claim 6; and
a rotor portion supported to be rotatable about a central axis with respect to the stator portion.
